(19) United States
(12) Patent Application Publication
(10) Pub. No.: US 2010/0138007 A1
(43) Pub. Date: Jun. 3, 2010

(54) APPARATUS AND METHOD FOR INTEGRATION AND SETUP OF HOME AUTOMATION

(75) Inventors: Jeff M. Clark, Conroe, TX (US); Christopher P.L. MacGregor, Seabrook, TX (US)

Correspondence Address: FULBRIGHT & JAWORSKI, LLP, 1301 MCKINNEY, SUITE 5100, HOUSTON, TX, 77010-3095, US

(73) Assignee: QWEBL, Inc., Houston, TX (US)

(21) Appl. No.: 12/623,996

(22) Filed: Nov. 23, 2009

Related U.S. Application Data
(60) Provisional application No. 61/116,844, filed on Nov. 21, 2008.

(51) Int. Cl. G06F 17/00; G06F 3/048

(52) U.S. Cl. 700/90; 715/771

(57) ABSTRACT

A domotics system is disclosed for automatically discovering devices to add to or modify on a home automation system, configuring a home automation set top box and hardware devices/systems in the home, configuring the user interface of a control point to automatically and/or manually carry out a user's request/command to invoke the services of a device/system/subsystem, and preconfiguring the home automation system to invoke device and system services in response to an event specified by the user.

### RELATED APPLICATION

This application claims priority to U.S. Provisional No. 61/116,844, filed Nov. 21, 2008, the contents of which are hereby incorporated by reference in their entirety for all purposes.

### TECHNICAL FIELD

The system and method relate generally to the field of domotics, and more specifically, but not by way of limitation, to a system and method for integrating devices and control points for home automation systems.

### BACKGROUND OF THE INVENTION

Home automation technologies allow users to remotely monitor and control a variety of devices and systems in their homes, including but not limited to heating and cooling systems, video cameras/recorders, security, draperies and blinds, home entertainment systems, electrical outlets, networked devices, outdoor watering systems, garage doors, fireplaces and lighting, for example. Such devices and systems are typically linked to a master control system that acts as a server, such as a computer or set top box, via a serial port, universal serial bus (“USB”), radio frequency (“RF”), infra-red (“IR”) or another wired/wireless link. Users control the devices and systems from control points, such as wall-mounted touch panels positioned in the home, or remote communications enabled devices (e.g., PC, personal digital assistant (“PDA”), mobile phone, etc.) The master control system carries out commands received from the control point to control devices in the network. In typical home automation systems, control points communicate with the master control system using the Universal Pier-to-Pier (“UPnP”) protocol, a TCP/IP based architecture, and the master control system communicates with devices using one or more standard automation protocols such as X10, Insteon, ZigBee, EIB, EHS, LONWorks, HomPlug, BACnet, and/or UPnP, for example.

Installation and setup of home automation systems have traditionally been very expensive, particularly for complex, multi-device home automation systems. The problem is that multi-device systems require system integrators to program the master control system, each device, and each control point to communicate with each other, typically on a one-by-one basis. Such programming may require the integrator to have extensive knowledge of programming languages and communication protocols in order to enable communications. As a result, the integration, configuration, and set-up process must be performed by experienced software and hardware professionals. Even with such expertise, integrators may toil for countless hours programming and reprogramming hardware and software for the user interface, master control system, and devices, at substantial cost to the user.

By way of example, the process of configuring a single light switch through previously known methods can be appreciated from FIG. 1. FIG. 1 is a graphical depiction of a typical home automation system with a touch panel 110 control point linked to a set top box 140 and light 170 device. In FIG. 1, hardware components are shown as rectangles having sharp corners, software routines are shown as rectangles having rounded corners, input values are shown on the left side, and output values are shown on the right side. The dotted lines connecting software routines show information/parameters passed from one routine to another.

After connecting a device to the set top box 140 (the master control system) through a wired/wireless link, the integrator must ensure the set top box 140 can control light 170 and its services (e.g. on/off, start/stop, etc.). Each device has a unique identifier, for example, light 170's ID=001. The integrator programs the light software module 160 to read input, ID=001, from the ID output pin of light 170. Then the integrator programs the light's software module 160 to obtain its Status input from the Status output pin of light 170. The integrator then programs the light's software module 160 to control the light's ON/OFF setting from light 170's ON/OFF input pin. Similarly, the integrator programs the light's software module 160 to control the light's dimmer by passing the value of the dimmer setting from the light's software module output pin to light 170's input pin.

At this point, the integrator must ensure the touch panel 110 control point includes a control button for light 170. The integrator programs user interface 120's software to include button N 130 and then programs button N 130 to receive two input values—ID and Status—each passed from the light's software module 160 as output. Outputs of button N—ON/OFF and Dimmer—pass as inputs to the light's software module 160. In this way, the integrator enables button N to communicate with the light. However, at this point, button N merely has the label ID=001 and thus does not provide the end user any descriptive information as to what device the button control or the light's physical location. The integrator must therefore assign button N a meaningful name, such as Bedroom Light, which will be displayed on control button N 130.

The above configuration process must be repeated for each device in the home automation system during installation and when new devices are added. As should be evident, the typical configuration process of home automation system requires establishing relationships between the master control system, devices, and control points, as outlined above. This setup process is time-consuming and confusing, has a high probability for error, and is difficult to debug or revise. A more efficient, dynamic, system and method is desired.

### BRIEF SUMMARY OF THE INVENTION

One embodiment of the invention provides a system for installing and configuring the operations of elements of a home automation system (e.g., set-top boxes, control points, and devices). The system includes a discovery process for identifying devices in a user's home and collecting static control information for each device. The system also includes a configuration process for displaying discovered devices to a user, receiving descriptive user interface information about the devices from a user, and storing the user interface corresponding static control information for each device to enable system communications. The configuration process also configures a control interface for a control point, marking control buttons with the received user interface information so that users can easily identify and control each device. The system further includes a scene builder process that allows the user to invoke and schedule operations of one more devices in response to triggering events.

### BRIEF DESCRIPTION OF THE DRAWINGS

FIG. 1 shows the hardware and software of an example home automation system known in the art;

FIG. 2 shows an example embodiment of the disclosed embodiments including a plurality of control points networked with a master control system and a plurality of devices in the home;

FIG. 2A shows the data flow between elements of the home automation system in an example embodiment of the disclosed embodiments.

FIG. 3 shows the device discovery process according to an example embodiment of the disclosed embodiments;

FIG. 4 shows the configuration process according to an example embodiment of the disclosed embodiments;

FIG. 5 shows the scene builder process according to an example embodiment of the disclosed embodiments;

FIG. 6A and FIG. 6B show example user interfaces for the device discovery process;

FIGS. 7A, 7B, and 7C show example user interfaces for the configuration process;

FIG. 8A, 8B, 8C, 8D, 8E, 8F show example user interfaces for the scene builder process.

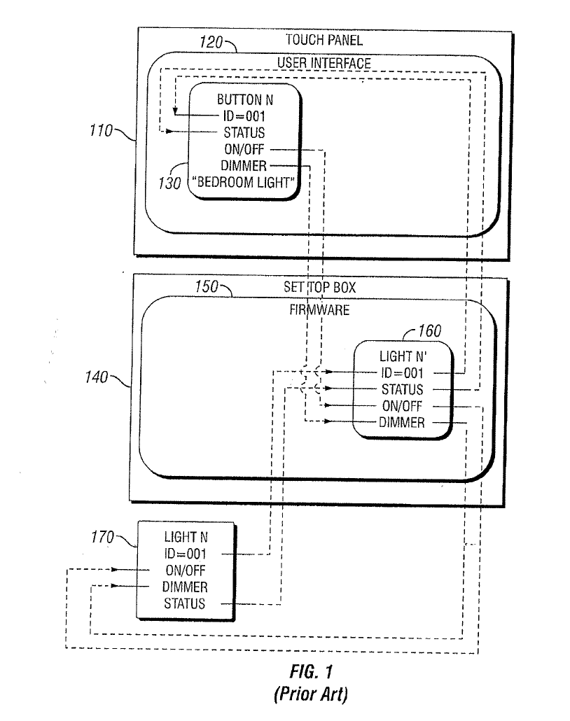

### DETAILED DESCRIPTION OF THE INVENTION

Aspects of the disclosure embodiments are best understood from the following detailed description when read with the accompanying figures. It is emphasized that, in accordance with the standard practice in the industry, various features are not drawn to scale. In fact, the functionalities of various features may be arbitrarily increased or reduced for clarity of discussion. It is also understood that, for purposes of clarity, like reference numerals identify like structures in each of the figures. The framework disclosed herebelow is preferably implemented by a computer executable program and/or hardware, according to practices known to those of ordinary skill in the art. It is to be appreciated by those of skill in the art that the processes described herein may be implemented as instances of a computer program, or circuitry hardware; and such programs or hardware (each a “module”) may be positioned on the elements of the home automation as shown in the Figures, or distributed across the various elements to carry out embodiments disclosed herein.

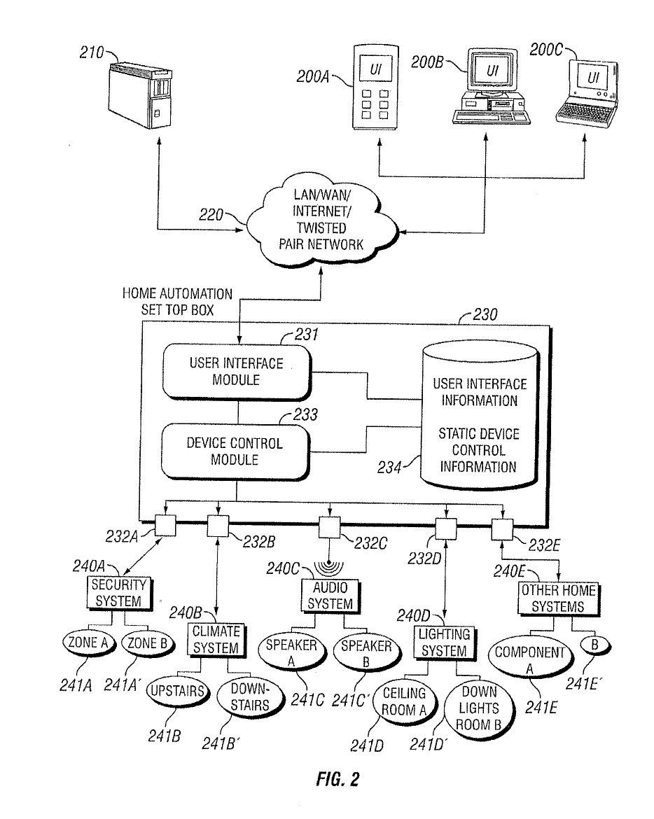

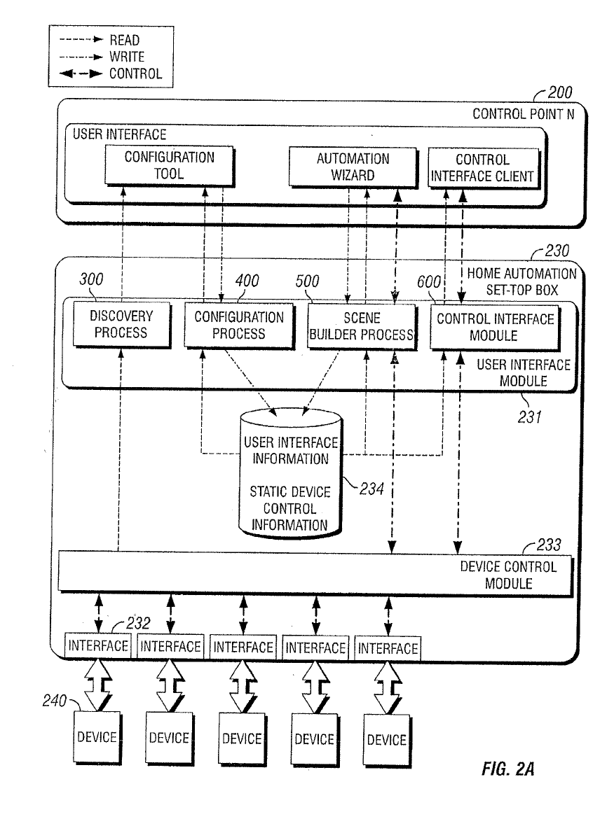

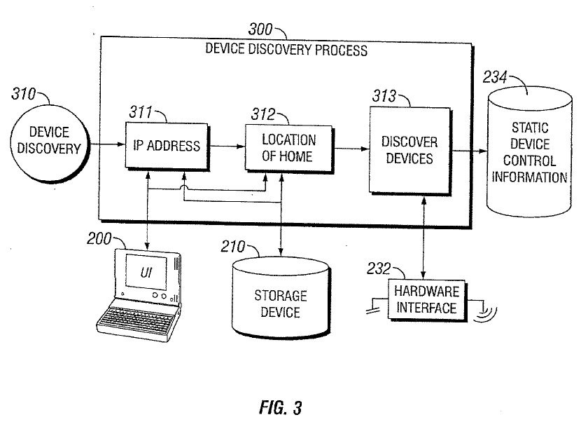

FIG. 2 shows a plurality of control points, devices in the user's home, and a home automation set top box. These elements make up the home automation system in the disclosed embodiments as discussed below.

The control point is a remote device, such as a mobile phone 200A, desktop computer 200B, laptop 200C, PDA, etc. The control point preferably includes a web browser, an Extensible Markup Language (“XML”) parser, and General Event Notification Architecture (“GENA”), as well as support for HyperText Transfer Protocol (“HTTP”), Simple Service Discovery Protocol (“SSDP”), and Simple Object Access Protocol (“SOAP”) to enable inter-device and intra-network communication. In certain embodiments, a peer-to-peer networking architecture is desired between the elements. In this scenario, the home automation set top box 230, devices 240, and control points 200 possess IP connectivity and include the above embedded features and protocol support. The control point's user interface (“UI”) provides a mechanism for the user to interact with the system. Message exchange preferably follows proprietary communication protocols or, alternatively, known communications protocols such as X10, Insteon, ZigBee, EIB, EHS, LONWorks, HomPlug, or BACnet, for example.

When users access the system, the control points (200A, 200B, 200C) shown in FIG. 2 preferably establish a secure link or tunnel to home automation set-top box 230. The secure link is achieved by a firewall or encryption technology used for securing communications over a network 220 (e.g., Internet, wide/local area network, twisted pair link, cellular, GSM (2G), UTMS (3G), 4G, edge, etc.) in a known way.

Devices 240A-240E are preferably connected to home automation set-top box 230 via RF, IR, or twisted pair. The hardware interface 232 may be an RF transceiver, IR port, serial port, USB, Wi-Fi, Firewire, IP gateway, or any other known interface. In the preferred embodiment, the hardware interface 232 establishes a wireless connection from the home automation set top box 230 to devices 240A-240E. The external devices may be any components of a home automation system, including any type of appliance and system. External devices shown in FIG. 2 comprise a security system 240A, climate system 240B, audio system 240C, lighting system 240D, and any other home system 240E, for example. Each device 240A-E may also include sub-devices or sub-systems, which are identified in FIG. 2 with reference numerals 241A, 241A′, 241B, 241B′, 241C, 241C′, 241D, 241D′, 241E, and 241E′, respectively. Devices 240A-E preferably act as clients and the master control system acts as a server.

The home automation set top box 230 (server) is preferably located in a user's home; alternatively it is remote from the home. In the preferred embodiment, the home automation set top box 230 is manufactured by Crestron Electronics, Inc or AMX®. In one embodiment, a device control module 233, a user interface module 231, and a storage medium 234 reside on the home automation set top box 230 and interact with corresponding processes of the control point 200. Modules 231 and 233 are preferably computer executable files that are run by a processor on the home automation set top box 230. Generally, the modules enable untrained users to efficiently set-up and configure interoperation of devices in the home automation system. The modules also allow users and installers to control the devices remotely.

FIG. 2A shows one embodiment of the structures of the control point 200 and home automation set top box 230 in greater detail. A configuration tool, automation wizard and control interface client are preferably provided on the control point to carry out the read, write, and control messaging to install and setup the home automation system. The configuration tool, automation wizard, and control interface are preferably software modules (and alternatively, hardware modules) that the user accesses via the user interface of the control point. As noted above, one or more corresponding software applications, or computer circuits residing on the home automation set-top box 230, communicate with the configuration tool, automation wizard, and control interface to carry out embodiments of the invention. These software applications or circuitry on set-top box 230 may provide one or a plurality of system tasks including discovering devices, configuring a user interface, building scenes, and controlling devices. In the preferred embodiment these tasks are performed by single software module with a process/function for each such task (e.g., the discovery process 300, configuration process 400, scene builder process 500, and control interface module 600); however those of skill in the art will appreciate a variety of suitable implementations are possible to implement aspects of the invention.

Arrows shown in FIG. 2A indicate typical data flow between the software and hardware elements. Data flow is preferably read, write, and/or control as indicated by the legend. Other data flow arrangements are also envisioned. As shown, the configuration tool reads data from the discovery process 300, such as routing information, and reads from and writes the data to the configuration process 400; the automation wizard reads from and writes to the scene builder process 500 and sends control messages to the device control module 233 directly (not shown) or indirectly (FIG. 2A); the control interface client reads data from the control interface module interface and sends control messages to the device control module 233 directly (not shown) or indirectly (FIG. 2A). Alternatively, the configuration tool and automation wizard write data directly to the storage medium 234 (not shown) such as when configuring a user interface, for example. Similarly, the discovery process may also write data directly to the storage medium 234 for devices it identifies (also not shown). Data written to the storage medium 234 is accessed by system processes as needed.

For easy installation of home automation systems, the configuration tool provides users a mechanism for (i) identifying devices in the home that exist and can be connected with a home automation set-top box, and (ii) configuring a control interface to display user interface information, which is preferably a description of each device (e.g., label, name, room, etc.) so that a user can view and control device operations from control point 200.

The user begins the installation process through the configuration tool by searching for devices in the home. In response, the device control module 233 reads static device control information for each device 240 by operation of the device discovery process 300 (described in FIG. 3). Static device control information includes device ID, routing information, device functions, and/or device status, for example. Hardware interfaces 232 (shown as 232A-E in FIG. 2) provide the means for exchanging messages between the home automation set top box 230 and each device 240. Once obtained, the device control module 233 writes static control information for discovered devices to the storage medium 234, where it can be accessed during installation and operation.

Static device control information provides enough information for the home automation set top box 230 and hardware interface 232 to exchange control messages with each device 240. Because a typical user cannot identify device(s) 240 based on the static device control information alone, the configuration tool enables the user to physically locate and enter a label for each device via the configuration process 400 (described in FIG. 3). The label is ultimately displayed on the user's control interface for easy identification.

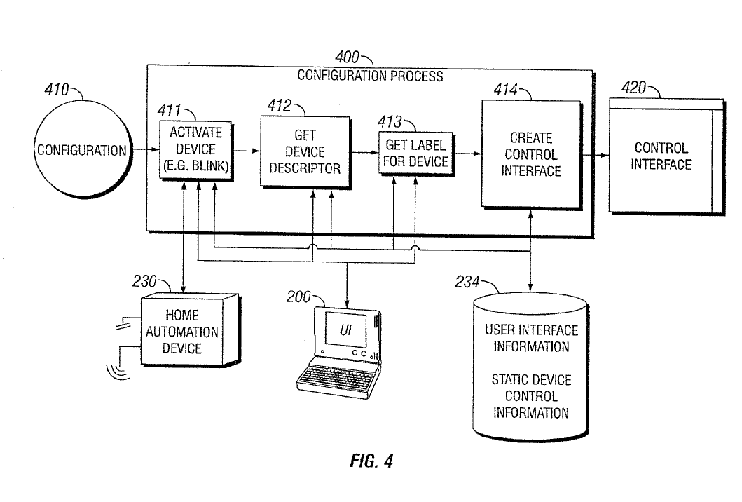

The configuration process 400 reads previously identified devices (and their static control information) from the storage medium 234 and presents this to the user via the configuration tool. Alternatively, the discovery process 300, device control module 233, or another structure (not shown) provides device information to the user's configuration tool. One-by-one, the user enters descriptive information about each device. The descriptive information represents how the devices will be displayed on the control interface. To match technical data with user-friendly information, the configuration tool assigns and associates the user interface information to corresponding static device control information, and then writes the relation directly to in storage medium 234 (not shown). Alternatively, as shown in FIG. 2A, the configuration tool writes the data indirectly to the storage medium 234 via configuration process 400. (See also FIG. 4.) In one embodiment, the user interface information and static device control information are stored together in a lookup table. In this way, a relationship is established between the user-provided-information and each device's communication-information; thus enabling user's to easily recognize and control devices from the control interface. Based on these relationships, the configuration tool creates a control interface for display on control point 200.

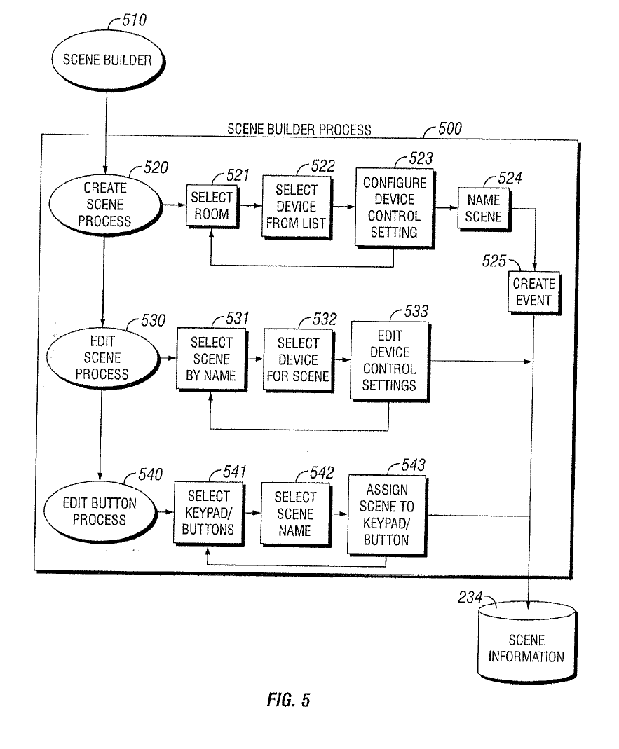

In another embodiment, the user creates groups of devices for concurrent operation using an automation wizard. The automation wizard enables the user to create logical containers for each group of devices, then name and store the container on the system. Alternatively, groupings are stored remotely at the administrator's server 210. Users can also set up the devices to begin operating in response to triggering events, which may be scheduled occurrence or button press on the control interface or as described in FIG. 5 in greater detail.

As shown in FIG. 2A, the control interface preferably resides on the control point 200. Once the above described installation and setup process is complete, a user can navigate the control interface to monitor and invoke devices and scenes in the home automation system. The user can also further configure the system via the control interface as desired. A protected connection between the control interface on the remote control point 200 and interface module 600 on the home automation device provide security for the system.

FIG. 3 shows an embodiment of the device discovery process. A user (e.g., system integrators/administrators, installers, home owners, technical support personnel, etc.) provides the IP address 311 to establish the home automation set top box 230 on network 220. A user also enters the location of the home 312 to allow the system to factor in location-specific factors (e.g. local weather and sunlight conditions). The IP address and location information may also be provided by system administrators during partial or complete installations. For usage control and oversight, administrators provide a list of approved devices that can be discovered via storage device 210.

Once established on the network, the device control module 233 (See FIG. 2, 2A) searches for devices 313 using discovery messaging. Discovery messages are exchanged via hardware interface 232 and devices 240. In general, discovery messages enable devices to advertise their services and search for other devices. The discovery messages preferably follow Simple Service Discovery Protocol (“SSDP”), however, other known protocols for discovering devices in client-server networks, peer-to-peer networks, appliance networks, and any other network may also be followed. When a device becomes active, the device broadcasts an alive message along with static device control information. The hardware interface 232 and device control module 233 listening for such messages parse the message and extract static device control information (e.g., location, hardware description, services, routing, ID, etc.). The configuration tool initiates the device discovery 310 at the user's request and process 310 writes static control information, the IP address and location to the storage medium 234, for use in the system.

As shown in FIG. 4, the configuration process 400 (i) enables the user to identify and name each discovered device (ii) establishes and stores user provided information—e.g., user interface information—for each device together with static device control information, and (iii) generates control buttons for a control interface that, when selected on a control point, control device operations. FIG. 2A shows the configuration process as part of the user interface module 231 on the set top box. Alternatively, the configuration process is 400 part of the configuration tool on the control point 200. Those of skill in the art will appreciate that distributed embodiments of the configuration process 400 may also be implemented.

First, the configuration process 400 displays static device control information to the user. Because this information is typically merely machine-recognizable (e.g., device ID, routing information), users must identify the device before providing descriptive information. To assist the user in identifying each device, the configurator 410 selectively activates each device one-by-one. For example, the configurator may blink the light, powering on/off audio equipment, or watering a sprinkler zone to attract the user's attention to such devices. In this way, a user can easily locate the device being configured. The user then inputs a meaningful description that identifies the device's location, purpose, function, etc. For example, the user may enter descriptors such as a room name 412 (living, dinning, master, patio, etc.) and a label 413 (wall lights, pool lights, left garage door, etc.). The configurator 410 stores the user's inputs and corresponding static device control information in the storage medium 234.

The configuration process 400 then configures the control interface based on information stored in the storage medium 234. The control interface is preferably an XML display incorporating static device control information and user provided user interface information. The control interface preferably includes one or more control buttons for each device in the home, which are marked with appropriate device names, room names, labels, descriptors, and/or any other identification information so the user can easily navigate the system and control the devices 240. When selected on the control point, control buttons trigger command and control messages that are sent over the network 220 to the home automation set top box 230 (such as via HTTP requests). The control interface module 600 parses and translates the messages and, in turn, forwards messages to the device control module 233 and hardware interface 232 to direct the messages to the appropriate device 240 (FIG. 2A). When the control point 200 receives error or status messages about device 240, the message is parsed and displayed on the corresponding control button of the control interface.

As shown in FIG. 5, the scene builder process 500 customizes the system for the user by establishing predetermined control settings. The control settings are stored to the system, preferably on storage device 234 in a logical container, where they can be accessed at a later time to create a desired environment in the home. The scene builder process 500 is shown as part of the user interface module 231 on the home automation set top box 230 in FIG. 2A; alternatively, the scene builder process 500 is part of the configuration tool on the control point 200 or distributed.

As shown in FIG. 5, the scene builder process 500 includes a scene builder 510 that manages the create scene process 520, edit scene process 530, and edit button process 540. The create scene process 520 displays a list of rooms in the house and the devices for each room to the user; the user then chooses room(s) 521 and device(s) 522 to include in a scene. The user also configures device control settings 523 to create the desired scene. For example, the user schedules adjustments/activation of the device's services, such as by presetting the device to power (part way) on/off, and/or to respond to an event (e.g, based on a time clock, motion sensor, local weather, scheduled maintenance, etc.) The user enters a scene name 524 to identify the scene at a later time, and then saves the scene's settings to storage medium 234. In one embodiment, the user creates events 525 that trigger a scene. Events 525 can include button presses on the control interface or a physical keypad button. Events may also be related to weather, daylight, television programming, time, or any other occasion. The control interface accesses storage medium 234 as needed to display scene operations and control buttons to the user.

The edit scene process 530, shown in FIG. 5, enables users to makes changes to existing scenes. Using the edit scene process 530, the user selects a scene by name 531, and chooses a device that is currently part of the scene 532. The user then adds and/or edits device control settings 533 to carry out the desired services. In one embodiment, the user can also edit the scene name if desired (not shown). The edit scene process 530 creates/updates the storage medium 234 with changes. Changes to scenes are reflected on the user's control interface automatically for increased efficiency.

The edit button process 540, shown in FIG. 5, configures the control button on the control interface according to instructions from the user. To do so, the edit button process 540 displays the control buttons 541, and scene names 542 for the user to select and edit. The edit button process receives input from the user, such as a scene name for a control button 543, and updates the storage medium scene information.

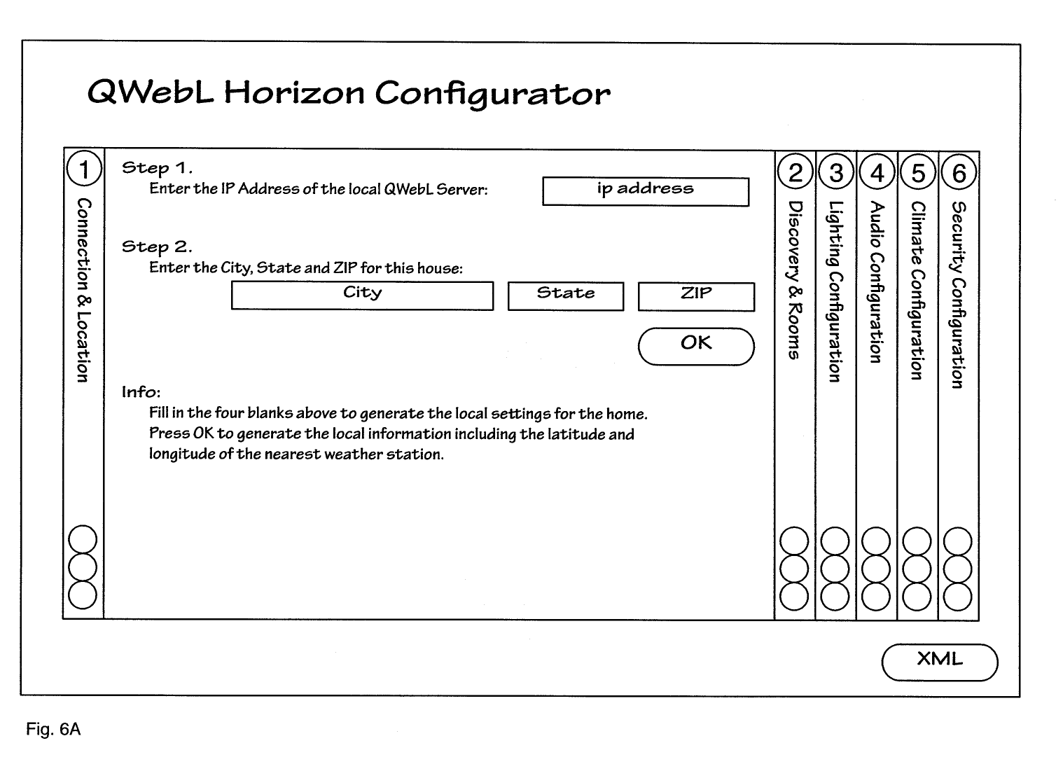

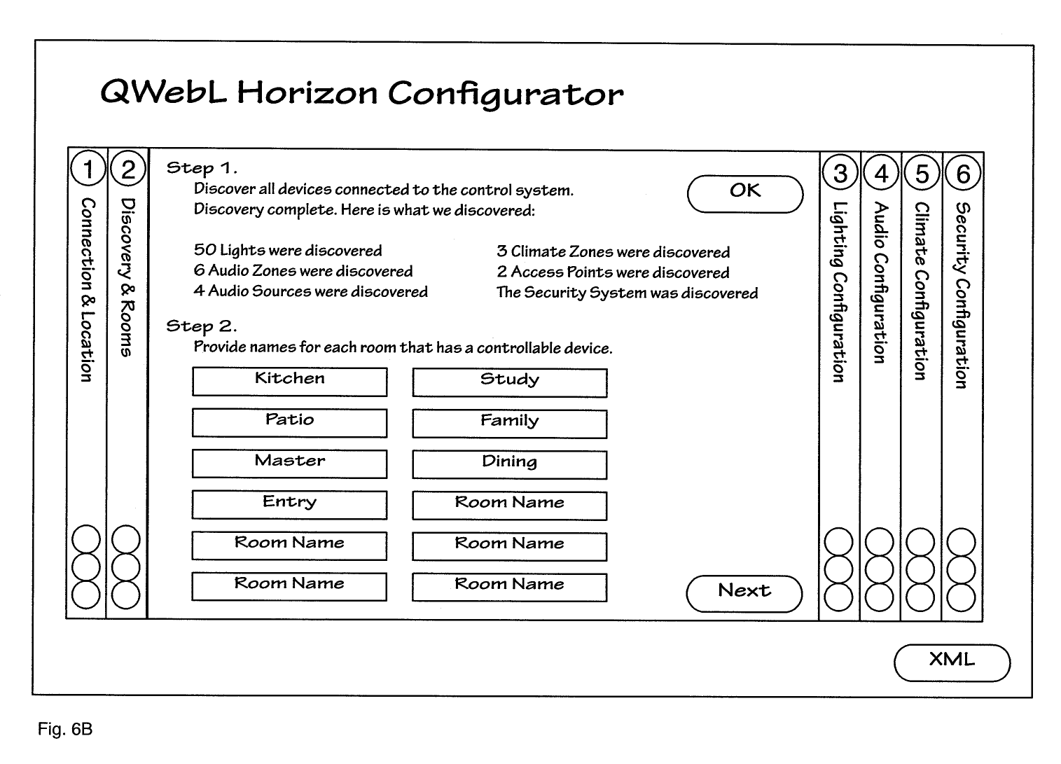

FIG. 6A shows an example configuration tool that may be displayed on a control point 200. The configuration tool is preferably programmed in XML, but other suitable languages may also be used as desired. In Step 1 the user enters the IP address of the local server. In Step 2 the user enters the city, state, and zip code for the house where the home automation set top box 230 (FIG. 2) is located. Based on these inputs, the device discovery process generates a list of local settings for the home and begins the discovery process. Optionally, the device discovery process 130 generates local information based on the user's inputs, including the latitude and longitude of the nearest weather station, which is used to optimize the climate controls, weather/sunlight based systems, and other systems dependant on the local environment.

FIG. 6B shows an example configuration tool used to a display the devices and static device control information. The configuration tool optionally collects information about the layout (e.g., floor plan) of the home. For example, in Step 1a list is generated for the number of and type of devices (e.g., lights, audio zones, audio sources, climate zones, access points, security systems, etc.). In Step 2 the user provides a name for each room where a discovered device exists. As shown in FIG. 6B, room names may include Kitchen, Patio, Master, Entry, Study, Family, Dining, for example, or any other room names.

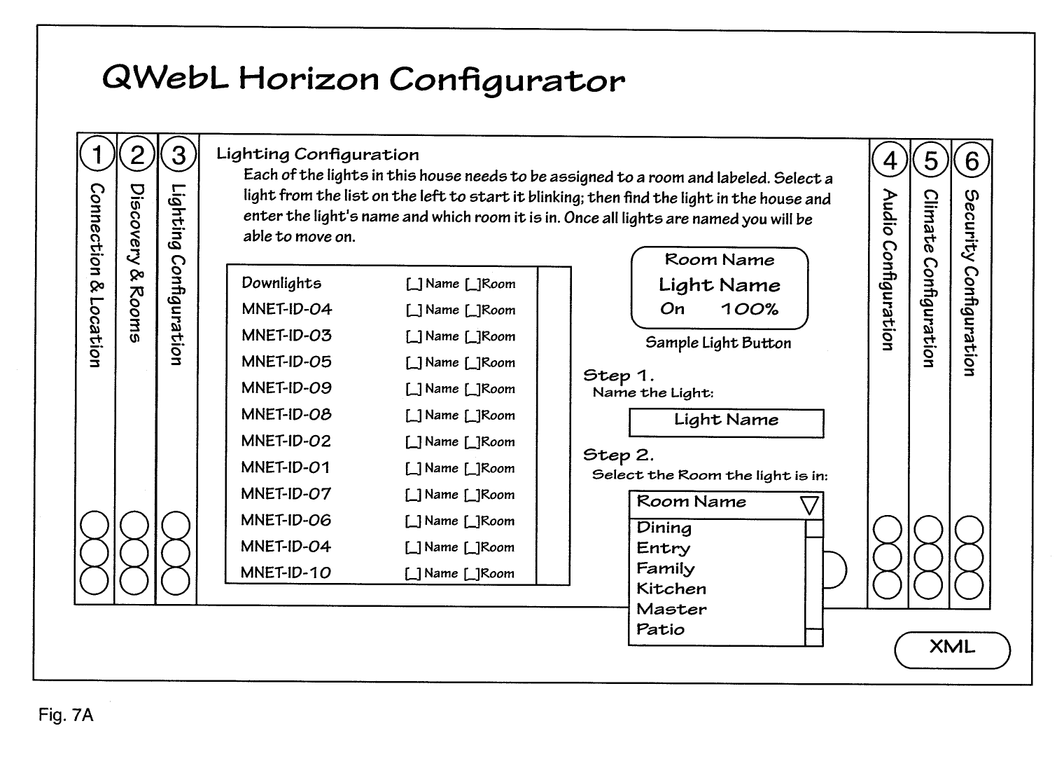

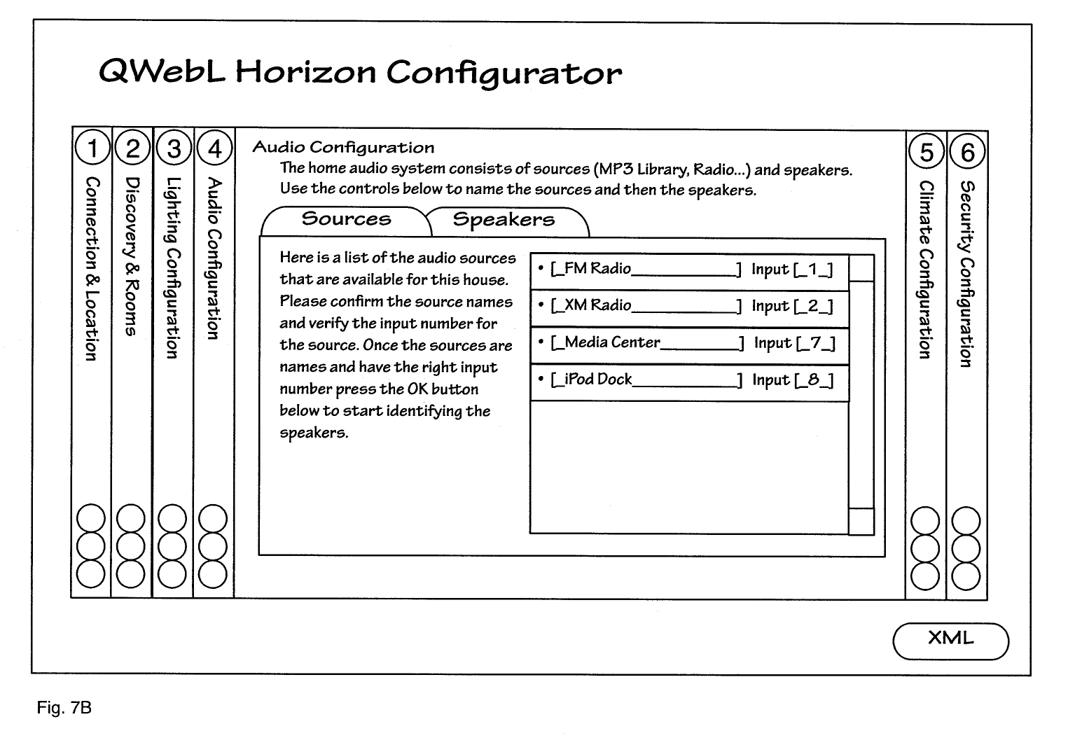

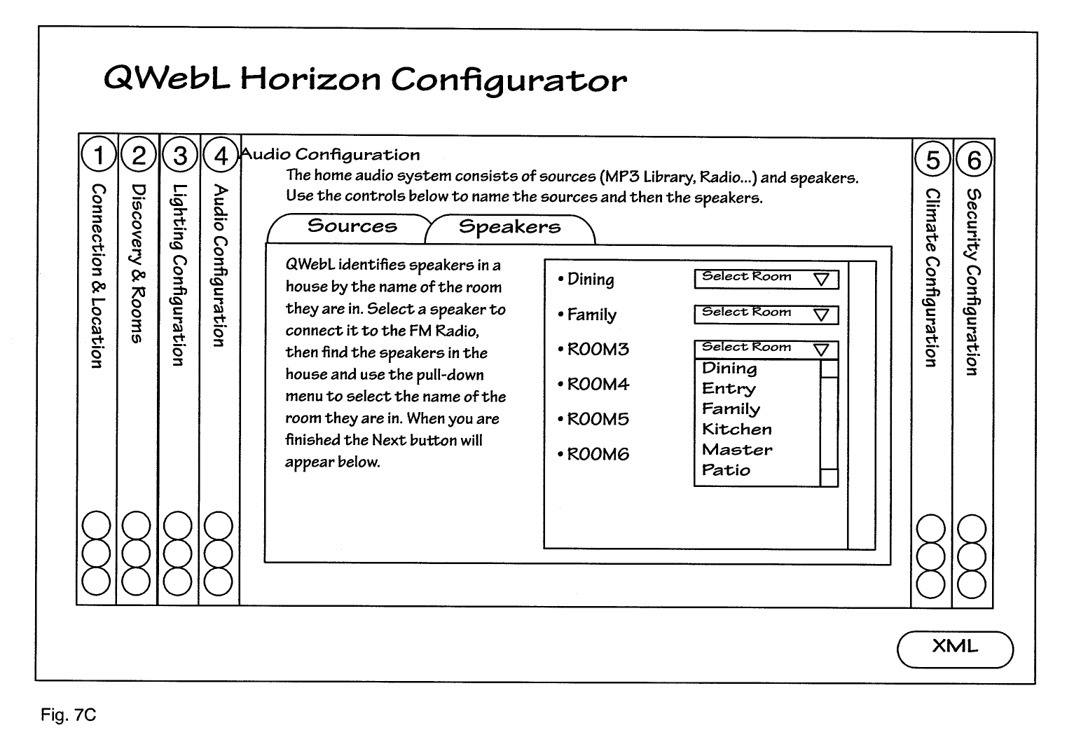

FIG. 7A shows an example display screen for configuration tool used to create control buttons from the control interface by operation of the configuration process 400. The sample control button displays information such as Room Name, Light Name, On/Off status, and power level. The user reviews the list of lights and selects a light to configure, which causes the light to start blinking. The user can then locate the light in the house or room and enter an appropriate description. In Step 1, the user assigns a Light Name to the selected light. In Step 2 the user enters or selects the room where the light is located. This information is assigned to a keypad or button displayed to the user on the control point.

FIG. 7B shows an example display screen for the configuration tool used to configure the audio components and source devices. Home audio source devices (e.g., MP3 library, radio, satellite media, speakers, etc.) are displayed, preferably in list form, so that the user can provide a source device name and an input number for the hardware interface 232 between the source device 240 and the home automation device 230 (shown in FIG. 2). For example, the source device FM Radio may be identified as Input: 1, XM Radio may be identified as Input: 2, Media Center may be identified as Input: 7, and iPOD Dock may be identified as Input: 6, as shown by the example in FIG. 7B. Once the source devices are named and identified with the appropriate input number, the user presses OK and begins identifying speaker devices (See elements 241C and 241C′ in FIG. 2).

FIG. 7C shows an example display screen for the configuration tool used to configure the speakers to play sound from the audio source devices. Speakers are preferably identified by the name of the room in the house in which they are located. The user selects one or more speakers to connect with each audio source device. For example, the user might select in the Dining room, Family room, or another room to play sound from the FM Radio. Upon selecting a speaker, the speaker is activated (See element 411 of FIG. 4) causing it to make an audible sound so the user can easily locate the selected speaker in the house. The user then selects the name of the room based on the location of the speaker.

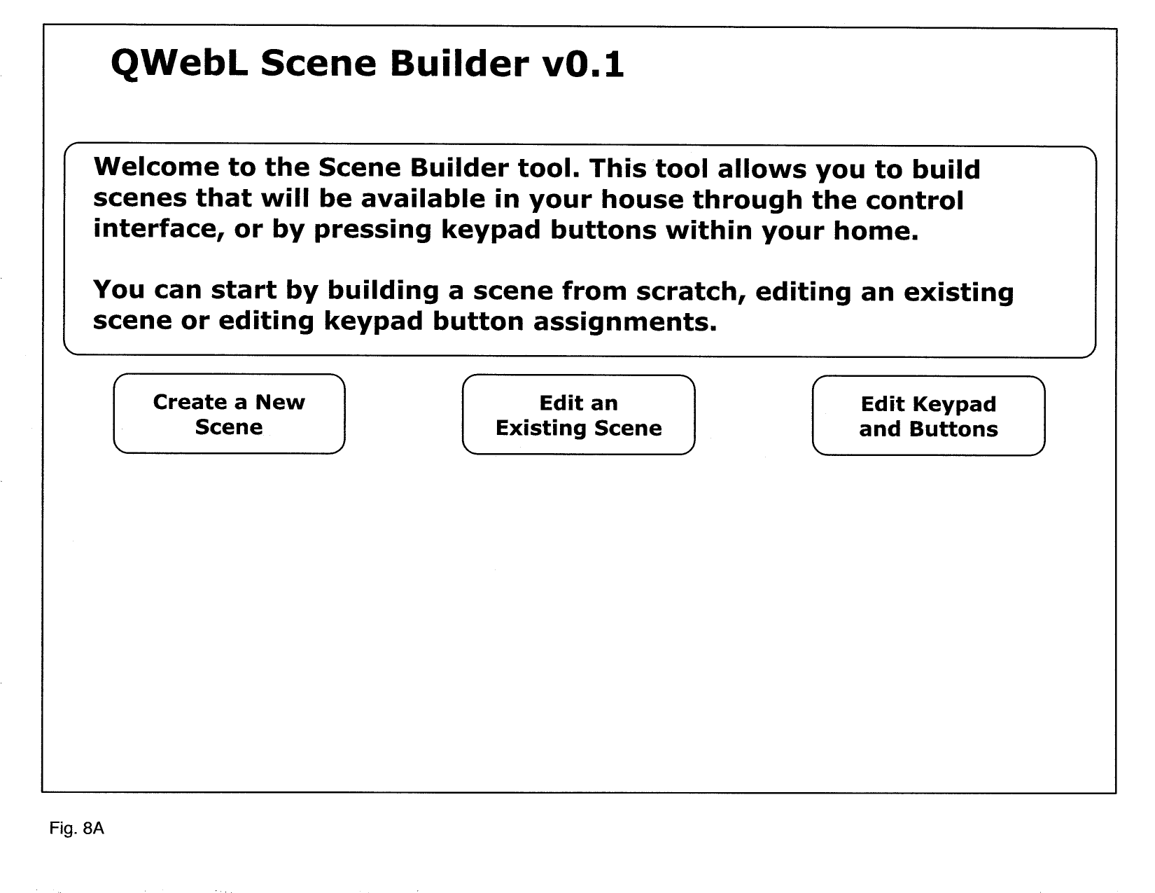

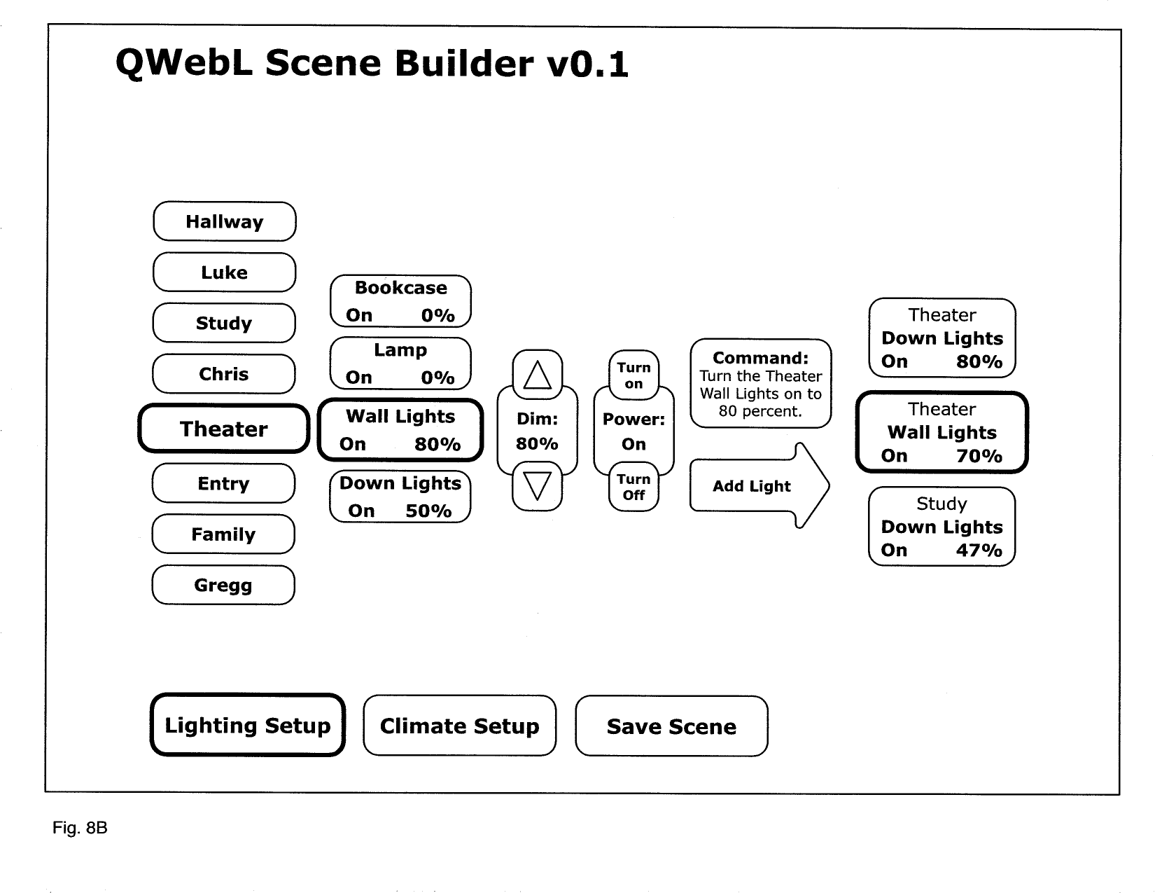

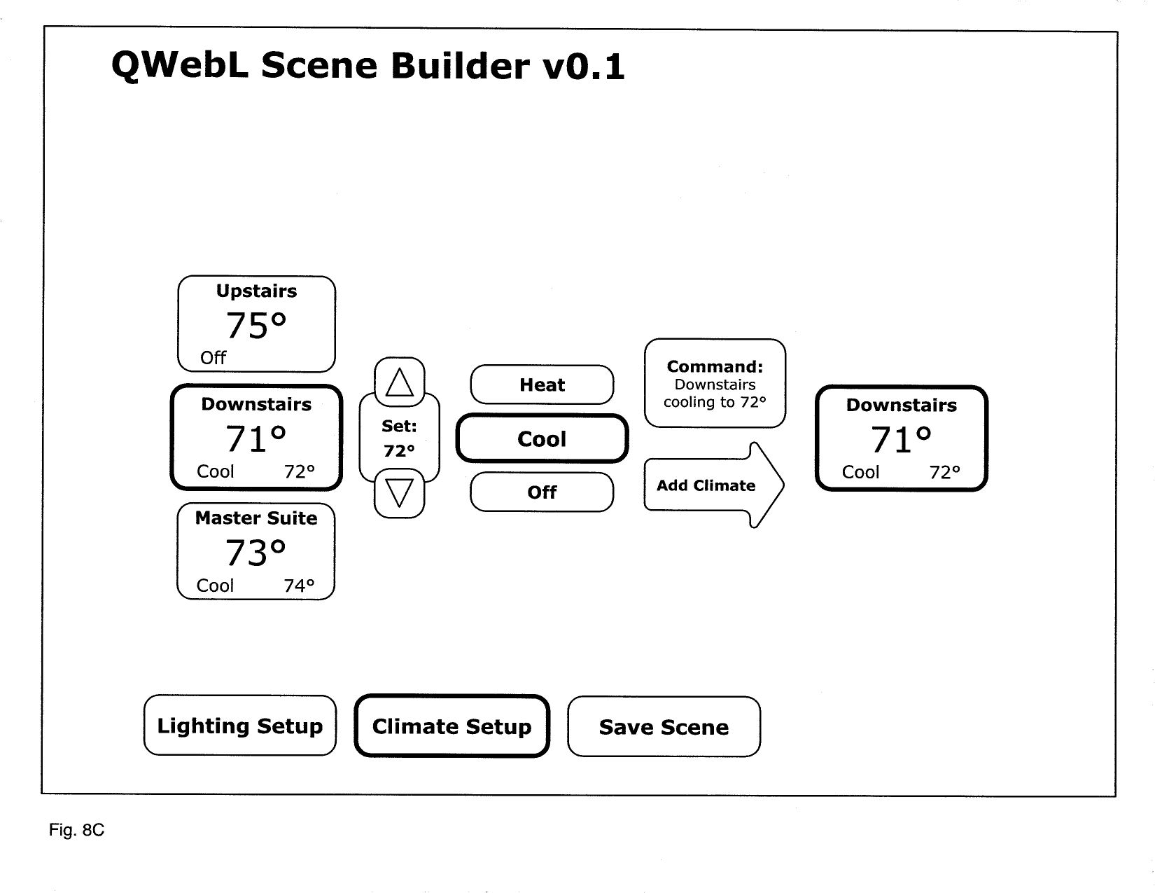

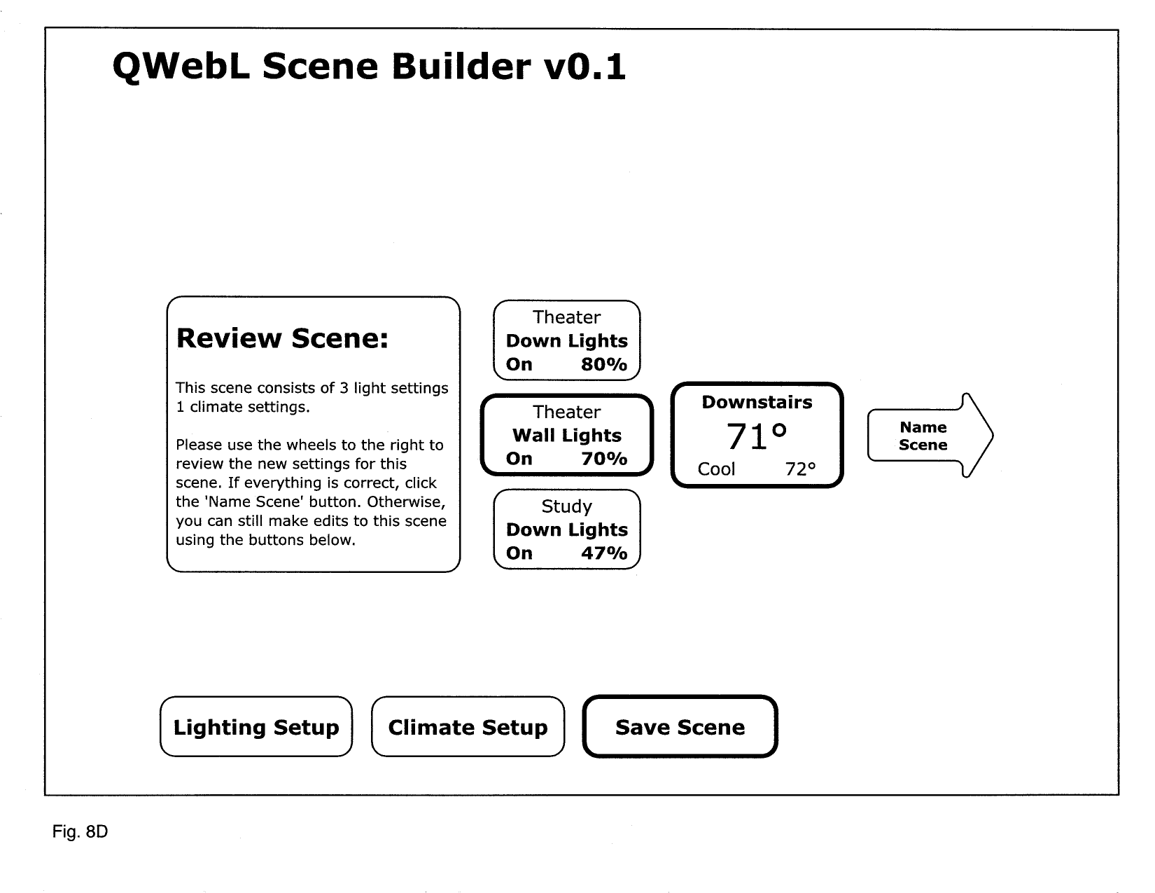

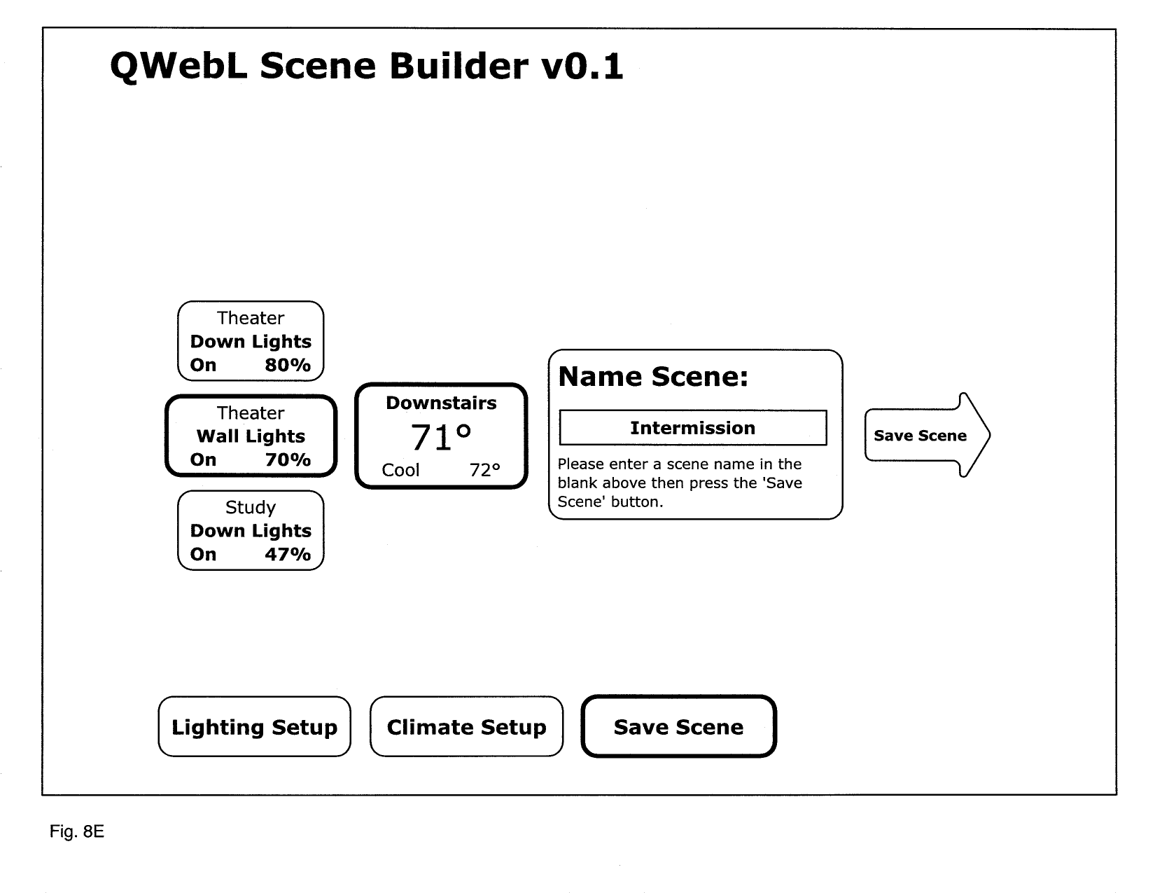

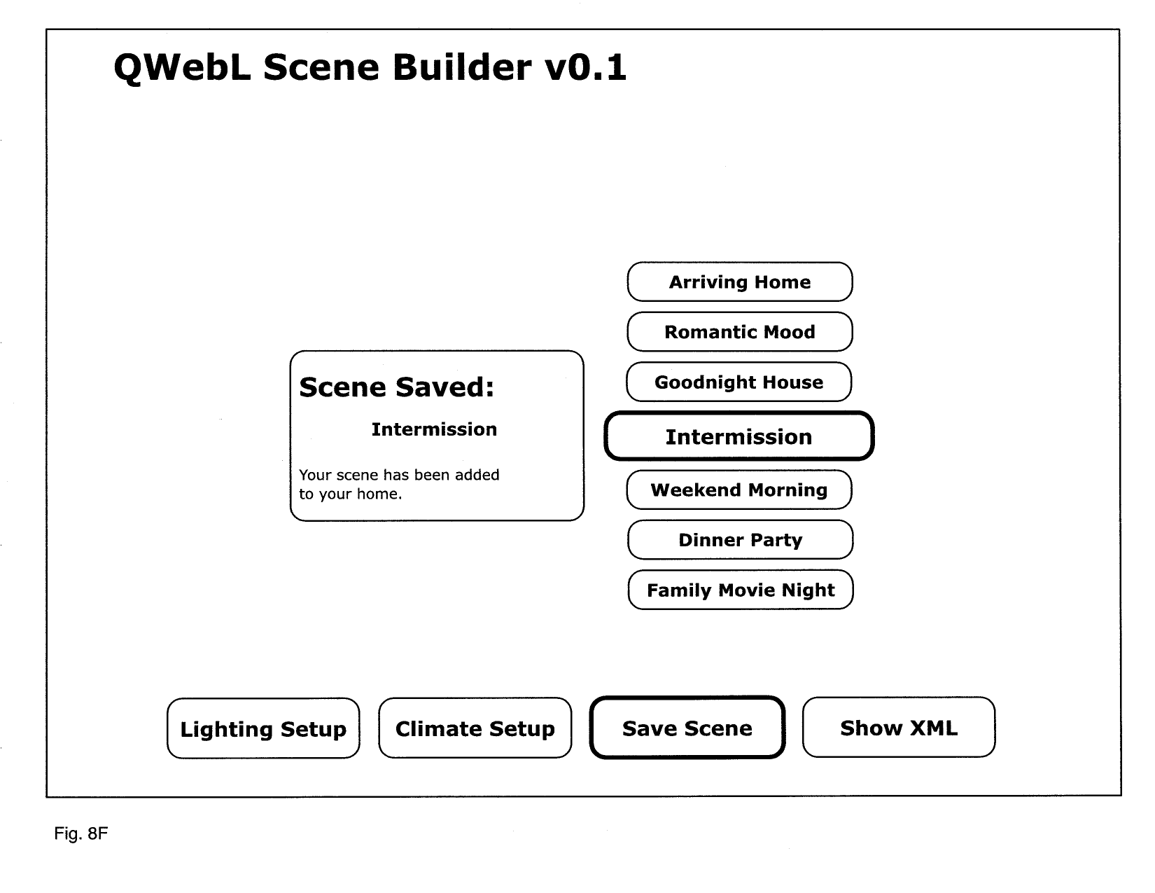

FIG. 8A shows an example display for the automation wizard, which is operable with the scene builder process 500. The display includes an example welcome message stating: “Welcome to the Scene Builder tool. This tool allows you to build scenes that will be available in your house through the control interface, or by pressing keypad buttons within the home. You can start by building a scene from scratch, editing an existing scene or editing key pad button assignments.” The display provides control buttons to activate the scene builder, including the Create a New Scene, Edit an Existing Scene, and Edit Keypad and buttons.

In FIG. 8B, users begin building a scene by selecting a room and device in the home. The rooms in the home are listed in the left most column and include Hallway, Luke, Study, Chris, Theater, Entry, Family, and Gregg. In FIG. 8B the user has chosen to setup devices in Theater and, as such, the devices in the Theater are listed in the second to left most column, including Bookcase Lamp, Lamp, Wall lights, and Down Lights. The user has further chosen to setup lighting devices in the Theater and, as shown, has configured the Wall Lights' dimmer control setting to “Dim: 80%” and the power setting to “Power: On”. A dialog box may also be displayed to show the user the command being entered, for example: “Command: Turn the Theater Wall Lights on to 80 percent.” Additional devices or lights can be added by selecting the Add Light button. Devices and (pre)settings chosen for a scene are displayed in the right most column of the example display screen. The device can be (re)selected for editing as necessary. At this point, the user's scene is made up of the devices in the Theater and Study (Theater Wall Lights are turned on to 80%; Theater Down Lights are turned on to 56%; Study Down Lights are turned on to 47%). Once the lighting devices are setup, the user can select “save the scene” to store the settings in the storage medium 234 for later use, or add climate controls using the Climate Setup control button.

FIG. 8C shows an example screen for setting up climate controls on the control interface. Rooms with climate controls are displayed to the user and, as shown in FIG. 8C, may include the 2^{nd} Floor, Kitchen-Family, and Master Suite, for example. The user modifies climate devices in the Kitchen-Family room by selecting the room, temperature, and unit (heat/cool/off). Note that in FIG. 8C the Kitchen-Family room is set to Cool at Set: 72°. An example dialog box showing the command entered by the user reads “Command: Kitchen-Family to cool to 72°.” Users can add additional climate control devices using the Add Climate control button.

FIG. 8D shows an example display screen used to review scenes and ensure the scene is setup as intended by the user. A dialog box may be displayed to summarize device settings for a particular scene, prompt the user to name a scene or make additional edits to a scene, or display additional information. For example, as shown in FIG. 8D, the dialog box may display a message such as “Review Scene: This scene consists of 3 light settings and 1 climate setting. Please use the wheels to the right to review the settings for this scene. If everything is correct, click the ‘Name Scene’ button. Otherwise, you can still make edits to this scene using the buttons below.” Scenes configured/edited in FIGS. 8B and 8C are shown and can be reviewed by the user in FIG. 8D.

When the user selects the Name Scene control button (shown in FIG. 8D) the dialog box shown in FIG. 8E is displayed. A text input field preferably appears within the dialog box, along with instructions for the user to complete the naming process. The user can then select the Save Scene button to preserve the scene's device settings.

FIG. 8F shows an example storage confirmation message that may be displayed to the user, which indicates a scene name—Intermission—and the message “Your scene has been added to your home.” FIG. 8F also shows further examples of stored scenes including Arriving Home, Romantic Mood, Goodnight House, Family Movie Night, Weekend Morning, Dinner Party, and Intermission.

As noted elsewhere, the user accesses scenes remotely or locally within the home via a control point 200 (e.g., via mobile phone 200A, computer 200B, etc.—See FIG. 2). Therefore, from any location, the user can call up a particular scene on the control point 200 and start the scene, or specify a time for a scene to begin. The user can also specify an event to trigger the scene. For example, the user may specify to start the “Arriving Home” scene (by turning on selected house lights) when the garage door is opened on weekday evening. Those of skill in the art will appreciate that the scene builder process 500 can set up any scene (or combination of scenes) that can be manually or automatically activated from a local or remote location.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. For example, the above described automation system may used in an office setting, as well as in the user's home; one or multiple devices, home automation set-top boxes, and control points may be included in the home automation system; the home automation network may be implemented with a traditional or distributed network architecture; and processes of the configuration and set/up module may be executed in any relative order to carry out objectives of the invention.

What is claimed is:

1. A system for adding devices to a home automation system and creating a customized user interface for controlling the devices comprising:
a device discovery module operable to search for and discover at least one device remote from the discovery module,
wherein the discovery module is adapted to identify and store routing information for the discovered device;
a configuration module operable to send a signal to a user device to notify a user about the presence of the discovered device, wherein the configuration module is operably coupled to the discovery module and remote from the user device, and
in response to the notification signal, the configuration module is adapted to receive a user-description of the discovered device from the user device and store into a memory device a relation between the user-description and the routing information so that signals may be routed to the discovered device in response to a selection of the user-description; and
wherein the configuration module is operable to generate a user interface for the user device that displays and receives selections for the user-description to control operations of the discovered device according to the relation.

2. The system of claim 1 wherein the discovery module is adapted for selectively activating a discovered device so that the user can identify the physical location of the device.

3. The system of claim 2 wherein the user-description includes the physical location of the discovered device identified by the user.

4. The system of claim 1 further comprising a memory device for storing the relation, wherein the memory device is accessible by a user device displaying the user interface.

5. The system of claim 4 wherein the configuration module adapts the user device to send a message to the discovered device controlling its operation in response to a selection of the user-description on the user interface.

6. The system of claim 1 wherein the memory device is integrated with a home automation set top box.

7. The system of claim 6 wherein the configuration module teaches a home automation set top box to receive instructions to operate the discovered device and route signals to the discovered device based on the relation stored in the memory device.

8. The system of claim 1 further comprising a scene builder operable to configure at least one scene.

9. The system of claim 8 wherein the at least one scene comprises a plurality of devices and/or device services assigned by a user.

10. The system of claim 9 wherein the scene builder is operable to configure a new scene and/or edit an existing scene.

11. The system of claim 10 wherein the scene builder configures the user interface to display a control button for the scene on the user device, and wherein the user device comprises a mobile phone, a computer, personal data assistant, and/or a touch panel.

12. A method for synchronizing and controlling devices in a home automation network comprising:
an interface configuration module discovering one or more devices in a home automation network, wherein the module is remote from the one or more discovered devices;
the interface configuration module presenting information representing the one or more discovered devices to a user device, wherein the module is remote from the user device;
the interface configuration module receiving instructions from the user device assigning the one or more discovered devices into a group to synchronize their operations;
the interface configuration module programming the user device to display a representation of the group of synchronized devices; and
the interface configuration module programming the user device to send instructions controlling operations of the group of synchronized devices in response to a selection of the representation of the group of synchronized devices on the user device.

13. The method of claim 12 wherein the step of discovering further comprises performing electronic device discovery in response to a request received from the user device.

14. The method of claim 13 wherein the step of discovering further comprises activating a discovered device so that a user can identify the physical location of the device.

15. The method of claim 14 wherein the step of activating comprises intermittently powering the discovered device on and off.

16. The method of claim 12 wherein the step of programming the user device further comprises assigning a name to a button on the user interface to indicate the group of synchronized devices under control and their physical locations.

17. The method of claim 16 wherein the step of programming the user device further comprises the step of assigning a scene name to a button on a user interface.

18. The method of claim 17 wherein the user interface is displayed on a user device connected to a home automation set top box over a communications link.

19. The method of claim 18 further comprising the step of programming the user device to display a scene name on the user interface so that a user can manually select the scene to initiate operations of the group of synchronized devices to create a desired environment in the home.

20. The method of claim 18 further comprising the step of automatically activating the scene in response to a triggering event.

21. The method of claim 20 wherein the triggering event comprises one or more of a scheduled time, weather, security alarm, motion detector, or daylight reading.

22. The method of claim 19 wherein the triggering event comprises button presses on the user interface, and wherein the user interface is a display screen or a keypad.

23. A method for setting up a home automation system comprising:
an interface module electronically discovering a device in a home automation network, wherein the module is remote from the discovered device;
the interface module identifying and storing information for controlling the discovered device into a memory device;
the interface module sending data representing the discovered device to a user device and, in response, receiving a user's description of the discovered device from the user device, wherein the interface module is remote from the user device; and,
the interface module storing the user's description of the discovered device into a memory device in relation to the information for controlling the discovered device.

24. The method of claim 23 wherein the memory device is integrated with a home automation set top box.

25. The method of claim 23 wherein the memory device is integrated with the user device.
